(19) United States
(12) Patent Application Publication
(10) Pub. No.: US 2002/0131115 A1
(43) Pub. Date: Sep. 19, 2002

(54) Wavelength multiplex transmission method and system

(75) Inventor: Junichi Kasahara, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO. LTD., Tokyo (JP)

(21) Appl. No.: 10/133,416

(22) Filed: Apr. 29, 2002

Related U.S. Application Data
(63) Continuation of application No. PCT/JP01/07381, filed on Aug. 28, 2001.

(30) Foreign Application Priority Data
Aug. 28, 2000 (JP) 2000-257689
May 15, 2001 (JP) 2001-145430

(51) Int. Cl. H04J 14/02; H04B 10/12

(52) U.S. Cl. 359/124; 359/173

(57) ABSTRACT

Wavelength multiplex terminal apparatuses (2 and 5) comprise transmissionreception devices (21 to 2N or 51 to 5N) in which light signals of 10-bit bit strings transmitted by transmission devices (11 to 1N or 61 to 6N) are converted into codes of 8-bit bit strings, according to a certain encoding rule, and presence of any code errors and RD errors are detected. The apparatuses (2 and 5) output transmission quality monitor signals and transmit them to a monitor and control device 8 via monitoring devices (2c or 5c) and a network (7) such that transmission qualities of the signals of the apparatuses (2 and 5) within a wavelength multiplex interval can be monitored.

### TECHNICAL FIELD

This invention relates to wavelength multiplex transmission method and system in which a plurality of light beams of different wavelengths are multiplexed and optically transmitted between nodes that are connected to each other.

### BACKGROUND ART

The conventional wavelength multiplex transmission system comprises a plurality of wavelength multiplex terminal apparatuses as nodes. Each of these wavelength multiplex terminal apparatuses includes optical multiplexer-demultiplexers and transmission-reception devices each having a transponder. The wavelength multiplex terminal apparatus is connected for example with SDH terminal apparatuses which transmit light beams based on SDH (Synchronous Digital Hierarchy) or transmission devices (for example, routers) which have an encoding rule for m/n bit conversion. A plurality of light signals of different wavelengths are multiplexed and optically transmitted between the wavelength multiplex terminal apparatuses (this interval between the wavelength multiplex terminal apparatuses referred to below as a wavelength multiplex interval). The receiving node receives and demultiplexes the light beams having corresponding wavelengths. In this system, it is required to monitor the qualities of the transmitted signals, to specify any sections where any bit errors have occurred within the wavelength multiplex interval in which wavelength multiplexing is performed. m and n mentioned above are arbitrary whole numbers, which represents number of bits used in the encoding rule used in the bit conversion.

The SDH terminal apparatus conforms to the ITU-T (International Telecommunication Union-Telecommunication standardization sector) recommendation, monitoring the transmission signal qualities by checking the B1 byte of the SOH (Section Over Head) in the SDH frame transmitted, using an OH (Over Head) monitor.

When the conventional system is connected with the SDH terminal apparatus, the transmission signal qualities are monitored using an OH monitor provided in the transmission-reception device by monitoring the B1 byte of the SOH in the SDH frame, as described above.

The transmission device such as a router has a MAC (Media Access Control) layer, which monitors the signal transmission qualities.

When the conventional system is connected with the transmission device, an optical transmitter-receiver in the transmission-reception device of the system receives Gigabit Ethernet Data standardized by the IEEE (Institute of Electrical and Electronics Engineers) 802.3 from the router and a CDR (Clock and Data Recovery) device in the system regenerates the output from the optical transmitter-receiver. An optical transmitter in the system converts the regenerated signals to signals with certain wavelengths, for transmission to a WDM (Wavelength Division Multiplex) transmission system. However, the wavelength multiplex terminal apparatus itself does not have the function of monitoring the signal transmission qualities. Therefore it has been impossible to monitor the signal transmission qualities in the wavelength multiplex interval.

It is an object of this invention to provide wavelength multiplex transmission method and system in which a wavelength multiplex terminal apparatus is equipped with means for monitoring the signal transmission qualities and in which any sections where any errors (bit errors) have occurred can be specified.

### DISCLOSURE OF THE INVENTION

The wavelength multiplex transmission method according to one aspects of the present invention is realized in a system in which a plurality of nodes each connected to at least one transmission device having at least one encoding rule for bit conversion are connected to one another via at least one optical transmission path, the nodes including a transmission node that transmits signals and a reception node that receives the signals. This method comprises an optical transmission step in which the transmission node multiplexes a plurality of light signals with different wavelengths and transmits the multiplexed light signals; and a reception step in which the reception node receives the multiplexed light signals transmitted by the transmission node and demultiplexes the received light signals into corresponding wavelengths. The reception step includes a conversion step of converting, based on the encoding rule, bit strings of the received light signals into codes having bit strings of a certain number of bits; and a rule determination step of determining whether the obtained codes comply with the encoding rule.

The wavelength multiplex transmission system according to one aspects of the present invention comprises a plurality of nodes each connected to at least one transmission device having at least one encoding rule for bit conversion; and at least one optical transmission path which connects the nodes with each other. The nodes include a transmission node that transmits signals and a reception node that receives the signals. The transmission node multiplexes a plurality of light signals with different wavelengths and transmits the multiplexed light signals. The reception node receives the multiplexed light signals transmitted by the transmission node and demultiplexes the received light signals into corresponding wavelengths. The reception node includes a conversion unit which converts, based on the encoding rule, bit strings of the received light signals into codes having bit strings of a certain number of bits; and a rule determination unit which determines whether the obtained codes comply with the encoding rule.

### BRIEF DESCRIPTION OF THE DRAWINGS

FIG. 1 shows an example of a configuration of the system using the wavelength multiplex transmission method according to the present invention; FIG. 2 shows an example of a structure of the transmission-reception devices illustrated in FIG. 1; and FIG. 3 is a flowchart which describes a process for determining any errors against the encoding rule defined in the decoder shown in FIG. 2.

### BEST MODE FOR CARRYING OUT THE INVENTION

Embodiments of wavelength multiplex transmission method and system according to the present invention will be explained in detail while referring to the accompanying drawings. The present invention should not be restricted to these embodiments and changes and modifications may be made without departing from the scope of the invention.

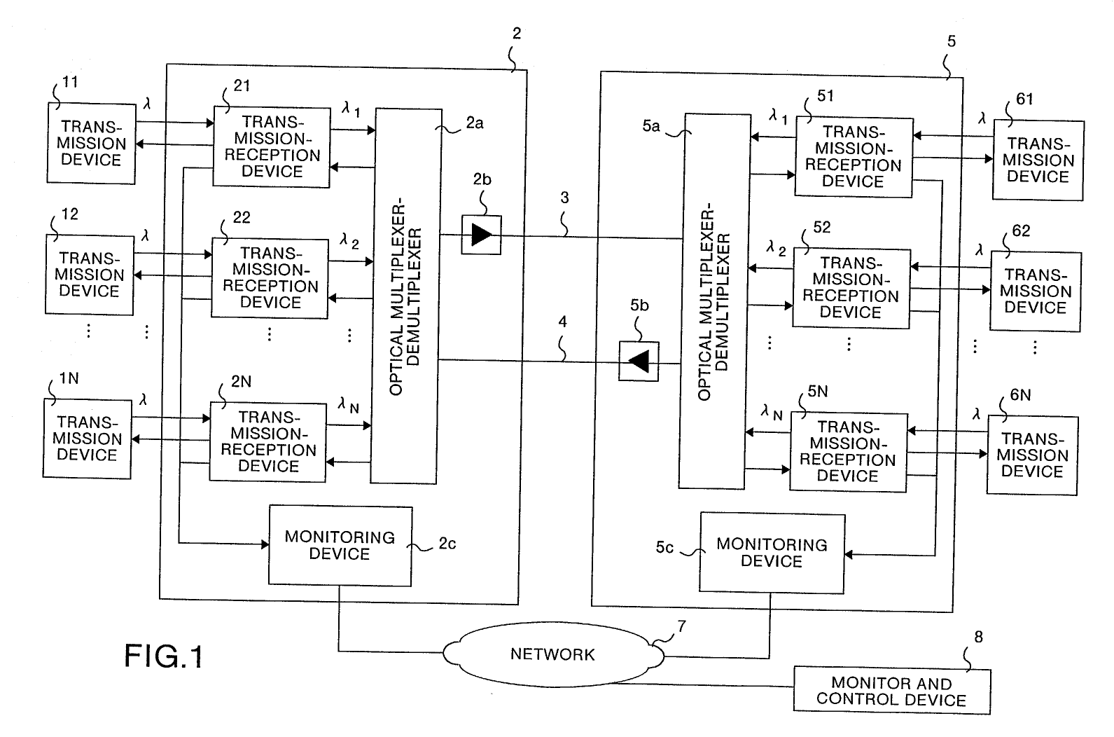

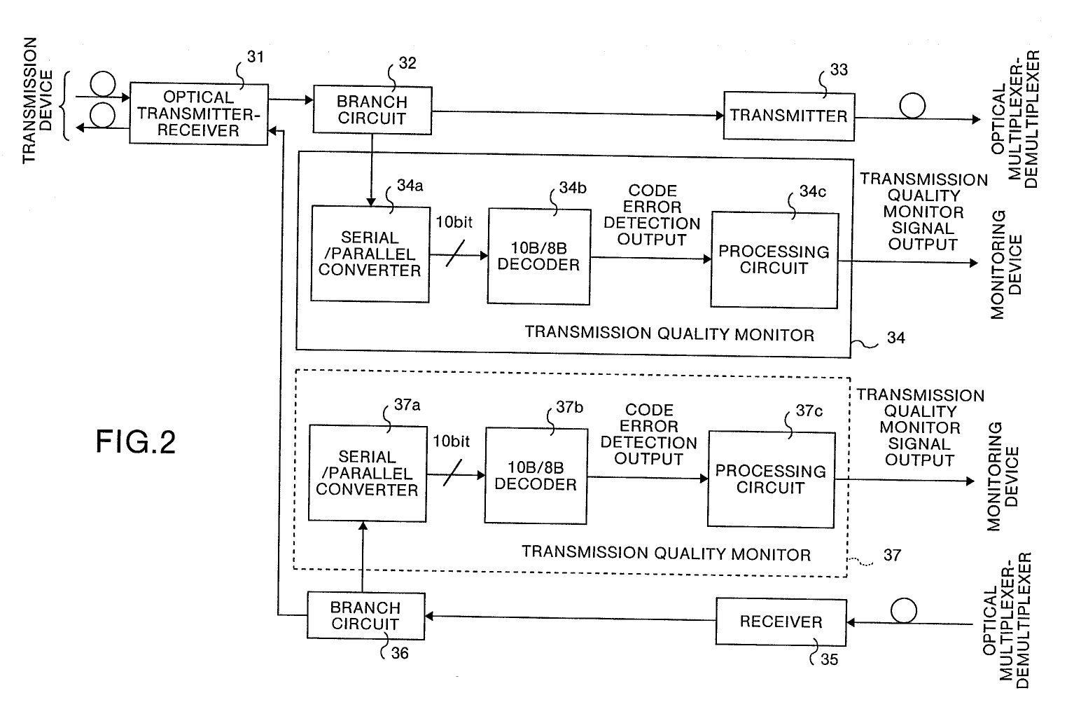

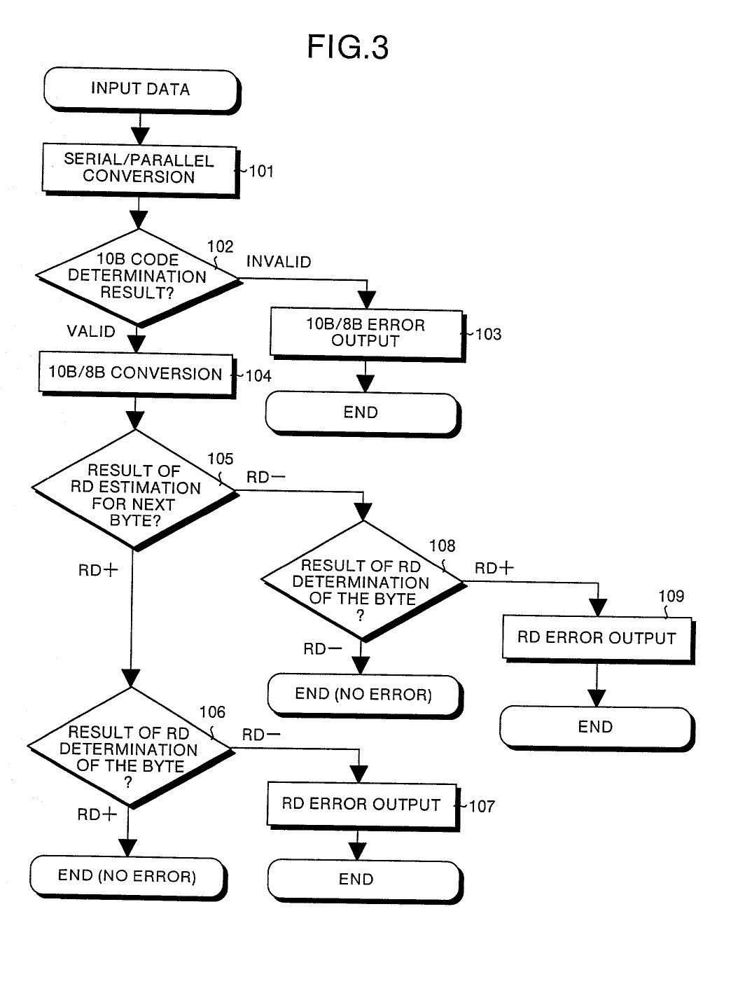

First, FIG. 1 shows an example of a configuration of the system using the wavelength multiplexing method according to the present invention. The system comprises a wavelength multiplex terminal apparatus 2 connected to transmission devices (routers) 11 to 1N each having an encoding rule for 8/10 bit conversion for example and a wavelength multiplex terminal apparatus 5 connected to transmission devices (routers) 61 to 6N each having the same encoding rule for 8/10 bit conversion.

These wavelength multiplex terminal apparatuses 2 and 5 are connected to each other via optical transmission paths 3 and 4. In addition the wavelength-multiplexing terminal apparatuses 2 and 5 are connected to a monitor and control device 8 provided in a network center not illustrated, via a network 7, which may be a network such as a leased line or an IP (Internet Protocol) network. The N used in the reference numerals is an arbitrary integer.

The transmission devices 11 to 1N and 61 to 6N convert each of for example a data code of 256 8-bit strings to a data code of its 2 corresponding 10-bit strings (negative and positive running disparities (RD)) according to a certain encoding rule.

That is, the transmission devices regulate the data codes transmitted to the wavelength-multiplexing terminal devices 2 and 5 such that negative and positive RD's are alternately repeated, to optically transmit a data code of 512 kinds of 10-bit strings. The regulated data codes are transmitted to the wavelength multiplex terminal devices 2 and 5, after undergoing parallel/serial conversion.

The wavelength multiplex device 2 comprises transmission-reception devices 21 to 2N, an optical multiplexer-demultiplexer 2a, an optical amplifier 2b, and a monitoring device 2c. The transmission-reception devices 21 to 2N transmit and receive light signals having an arbitrary wavelength of for example λ, to and from the transmission devices 11 to 1N. The optical multiplexer/demultiplexer 2a transmits and receives light signals to and from the transmission-reception devices 21 to 2N, the light signals having fixed wavelengths of for example λ1 to λN that can be wavelength multiplexed. The optical amplifier 2b amplifies the light signals multiplexed by the optical multiplexer/demultiplexer 2a and outputs the amplified signals to be transmitted via the optical transmission path 3. The monitoring device 2c is connected to each of the transmission-reception devices 21 to 2N, and monitors the transmission qualities of the light signals by sending information on any failures or alarms transferred from the transmission-reception devices 21 to 2N and information on input/output levels, to a monitor and control device 8 via the network 7.

The wavelength multiplex device 5 similarly comprises transmission-reception devices 51 to 5N, an optical multiplexer-demultiplexer 5a, an optical amplifier 5b, and a monitoring device 5c. The transmission-reception devices 51 to 5N transmit and receive light signals having an arbitrary wavelength of λ, to and from the transmission devices 61 to 6N. The optical multiplexer/demultiplexer 5a transmits and receives light signals to and from the transmission-reception devices 51 to 5N having wavelengths of λ1 to λN. The optical amplifier 5b amplifies the light signals multiplexed by the optical multiplexer/demultiplexer 5a and outputs the amplified signals to be transmitted via the optical transmission path 4. The monitoring device 5c is connected to each of the transmission-reception devices 51 to 5N, and monitors the transmission qualities of the light signals by sending the above information to a monitor and control device 8 via the network 7.

Each one of the transmission-reception devices 21 to 2N and 51 to 5N comprises the same components as shown in FIG. 2. An optical transmitter-receiver 31 receives Gigabit Ethernet data (signal) transmitted from the transmission device and a branch circuit 36 branches the signal received into two signals. A transmitter 33 converts one of the branched signals into a light signal having a fixed wavelength that can be multiplexed and sends the converted signal to the optical multiplexer-demultiplexer 2a (5a). The other branched signal is transmitted to a transmission quality monitor 34. The transmission quality monitor 34 outputs and sends a transmission quality monitor signal as a result of monitoring, to the monitoring device 2c (5c).

In the transmission-reception device, a receiver 35 receives the light signal from the optical multiplexer/demultiplexer 2a (5a) and converts it into a signal having an arbitrary wavelength λ and a branch circuit 36 branches the converted signal into two signals. One of the branched signals is sent to the optical transmitter-receiver 31 and then transmitted to the transmission device as Gigabit Ethernet data. The other branched signal is sent to a transmission quality monitor 37. The transmission quality monitor 37 performs later-described monitoring of transmission quality and transmits a transmission quality monitor signal as a result of the monitoring to the monitoring device 2c (5c). The transmission quality monitors 34 and 37 respectively comprise a serial/parallel converter 34a or 37a which converts an input serial signal into a 10-bit parallel signal, a 10-bit/8-bit decoder (“10B/8B decoder” or “decoder”) 34b or 37b which converts the 10-bit parallel signal into an 8-bit signal, and a processing circuit 34c or 37c which processes a signal representing code error detection output to output the processed signal as the transmission quality monitor signal.

Each of the 10-bit/8-bit decoders 34b and 37b functions as the conversion unit according to the present invention, the conversion unit which converts the data code from the transmission device into 8-bit bit strings in contrast to the transmission device, as described above. Moreover, the 10-bit/8-bit decoders 34b and 37b each functions as the first determination unit according to the invention, which determines whether the converted data code has any errors against a certain encoding rule, and a second determination unit according to the invention, which determines whether there are any errors in the running disparities of the data code and which comprises an LSI for example.

According to the present embodiment, a hardware (logical circuit) performs the bit conversion in accordance with for example a conversion table not illustrated, the conversion table defined by an ANSI X3.230 (Fiber Channel Physical and Signaling Interface). In this bit conversion, a hexadecimal number “00” for example can be represented as a negative 10-bit value, “1001110100” or a positive 10-bit value, “0110001011”, and the decoders 34b and 37b convert these 10-bit values into an 8-bit value, “00000000”. A hexadecimal number “01” is represented as a negative 10-bit value, “0111010100”, or a positive 10-bit value, “1000101011”, and as an 8-bit value, “00000001”. A hexadecimal number “1F” is represented as a negative 10-bit value, “1010110100”, or a positive 10-bit value, “0101001011”, and as an 8-bit value “00011111”.

The decoders 34b and 37d detect code errors per a predetermined bit string, that is, for example, byte by byte (per 8 bits), from all channels which have been multiplexed. As a result, if for example the overall transmission quality of the codes of all the channels is extremely degraded, transmitting all the code error detection output signals generated to the monitoring devices 2c or 5c will not be practical since an enormous amount of data will have to be transmitted.

Therefore, in the present embodiment, the decoders 34b and 37b process the code error output of a certain channel according to a setting described below before sending the output to the processing circuits 34b or 37b. That is, the decoders 34b and 37b divide one second into 8000 frames, and transmit information on whether there is a code error (whether a code error detection output signal is generated) in each divided frame, frame by frame, to the processing circuits 34c or 37c.

The processing circuits 34c and 37c count the number of frames with a code error according to the information on the code errors detected by the decoders 34b or 37b. The processing circuits 34c and 37c record the number to estimate for example a number of errors per one second in a certain channel at a certain time point. The monitoring devices 2c and 5c receive the error information per channel from each of the transmission-reception devices 21 to 2N or 51 to 5N and control the overall transmission quality of the system.

In the configuration shown in FIG. 2, the optical transmitter-receiver 31 receives a light signal having an arbitrary wavelength transmitted from one of the transmission devices 11 to 1N and the branch circuit 32 branches the light signal. The transmitter 33 converts one of the branched light signals to a signal having a fixed wavelength that can be multiplexed and transmits the converted signal to the optical multiplexer/demultiplexer 2a, which multiplexes the signal. The multiplexed signal is amplified by the optical amplifier 2b and transmitted along the optical transmission path 3.

As shown in the flowchart of FIG. 3, the decoder 34b determines whether there is a code error and an RD error per a certain bit string in the other signal branched by the branch circuit 32. That is, the serial/parallel converter 34a in the transmission quality monitor 34 converts the light signal into a 10-bit parallel code (step 101), and then determines if the converted 10-bit code is the code assigned by the encoding rule (step 102). If the code is an invalid code not assigned by the encoding rule the decoder 34b outputs and sends the error information to the processing circuits 34c (step 103).

If the code is a valid code assigned by the encoding rule, the decoder 34b converts it into a data code composed of 8-bit bit strings (step 104). After that, the decoder determines whether there is an RD error in the converted data code. If the data code received by the decoder is not composed of an alternate repetition of negative and positive RD's, the encoder determines that the code has an RD error and outputs a code error detection. In other words, since the data code has the alternate repetition of negative and positive RD's as described above, it is easy to predict whether a next portion of the data code to be received is going to have a negative or a positive RD.

Accordingly the RD of a next byte of the data code is estimated in step 105, and if the RD is estimated to be positive for example, and the input byte of the data code has a positive RD, it is determined that there is no error in the RD in step 106. If the input byte of the data code has a negative RD, it is determined that there is a code error and a detection of the code error is output (step 107).

Furthermore, if the RD of the next byte of the data code is estimated to have a negative RD for example in step 105, and if the input byte of the data code has a negative RD, it is determined that there is no error in the RD in step 108. If the input byte of the data code has a positive RD, it is determined that there is a code error and a detection of the code error is output (step 109).

The above-mentioned detection of code errors and RD determination can be similarly executed in the transmission quality monitor 37 since the transmission quality monitors 37 and 34 have the same configuration.

The processing circuit 34c processes the code error detection output signal as described above, and transfers the processed signal to the monitoring device 2c. The monitoring device 2c transmits the code error detection output signal to the monitor and control device 8 provided in the network center not illustrated via the network 7 and monitors the signal transmission qualities in the wavelength multiplex terminal apparatus within the wavelength multiplex interval. The monitor and control device 8 monitors any degradation in the overall signal transmission quality according to the code error detection outputs transmitted from each monitoring device and specifies the interval in which there is an error causing the degradation.

As explained above, according to the present embodiment, the Gigabit Ethernet data transmitted from the transmission device are branched, and the transmission quality monitor in the transmission-reception device receives the branched data. The data are then converted into data codes composed of 8-bit bit strings such that the transmission qualities of the signals in the wavelength multiplex interval can be monitored by detecting any code errors and running disparity errors.

Furthermore, even if the overall transmission quality happens to be degraded, it is possible to specify whether the degradation is caused in the system including the wavelength multiplex terminal apparatuses within the wavelength multiplex interval or in the transmission devices, since the transmission qualities of the Gigabit Ethernet data can be monitored.

In this embodiment, code errors and RD errors are detected to monitor the signal transmission qualities, however, the invention should not be restricted to the embodiment. For example, only the code errors or only the RD errors may be detected to monitor the signal transmission qualities.

Furthermore, the monitoring device is provided in each wavelength multiplex terminal apparatus, and the monitoring device receives the transmission quality monitor signal before it transfers the signal to the monitor and control device.

However, the monitor and control device may be provided in each wavelength multiplex device to directly monitor the transmission qualities instead.

Moreover, a bit conversion from 10-bit to 8-bit is described, however, any conversion from m-bit to n-bit may be performed. In addition, although the processing circuit divides one second of a signal into 8000 frames, it can be divided into an arbitrary number of frames. For example, the number of frames may be set according to the importance of the signal to be transmitted.

As explained above, according to the present invention, the wavelength multiplex terminal apparatus converts the light signal it receives into a code having bit strings of a certain number of bits according to the encoding rule and determines whether there are any errors in the code and the running disparities. As a result, the wavelength multiplex terminal apparatus has a function that monitors the signal transmission qualities and it is possible to specify the sections in which the errors causing the degradation have occurred even in case the overall transmission quality is degraded.

### INDUSTRIAL APPLICABILITY

As explained above, the wavelength multiplex method and the system using the method according to the present invention may be used in wavelength multiplex terminal apparatuses connected to a network such as a leased line or an IP network, for detecting any code errors and RD errors in Gigabit Ethernet data to monitor signal transmission qualities.

1. A wavelength multiplex transmission method to be realized in a system in which a plurality of nodes each connected to at least one transmission device having at least one encoding rule for bit conversion are connected to one another via at least one optical transmission path, said nodes including a transmission node that transmits signals and a reception node that receives the signals, the method comprising:
an optical transmission step in which said transmission node multiplexes a plurality of light signals with different wavelengths and transmits the multiplexed light signals; and
a reception step in which said reception node receives the multiplexed light signals transmitted by said transmission node and demultiplexes the received light signals into corresponding wavelengths, wherein the reception step includes
a conversion step of converting, based on the encoding rule, bit strings of the received light signals into codes having bit strings of a certain number of bits; and
a rule determination step of determining whether the obtained codes comply with the encoding rule.

2. The method according to claim 1, further comprising:
a transmission step in which said transmission device of said transmission node transmits light signals, following a set of running disparities wherein bit strings of negative and positive running disparities are alternately repeated; and
a disparity determination step in which said transmission device of said reception node determines any errors in running disparities of the light signals received by the corresponding node, in comparison with the set running disparities.

3. The method according to claim 2, further comprising a monitoring step, executed by said reception node, of monitoring transmission qualities of the received light signals according to the determination conducted in the rule determination step or the disparity determination step.

4. The method according to claim 1, wherein code errors are determined per a certain bit string and the result of the determination is output every predetermined period of time in the rule determination step.

5. The method according to claim 2, wherein running disparity errors are determined per a certain bit string and the result of the determination is output every predetermined period of time in the disparity determination step.

6. A wavelength multiplex transmission system comprising:
a plurality of nodes each connected to at least one transmission device having at least one encoding rule for bit conversion; and
at least one optical transmission path which connects said nodes with each other,
wherein said nodes including a transmission node that transmits signals and a reception node that receives the signals, said transmission node multiplexes a plurality of light signals with different wavelengths and transmits the multiplexed light signals, and said reception node receives the multiplexed light signals transmitted by said transmission node and demultiplexes the received light signals into corresponding wavelengths,
wherein said reception node including
a conversion unit which converts, based on the encoding rule, bit strings of the received light signals into codes having bit strings of a certain number of bits; and
a rule determination unit which determines whether the obtained codes comply with the encoding rule.

7. The system according to claim 6, wherein said transmission device of said transmission node controls running disparities of the light signals to be transmitted such that negative and positive running disparities of bit strings are alternately repeated,
wherein said reception node including a disparity determination unit which determines whether there are any errors in running disparities of the received light signals.

8. The system according to claim 7, wherein said reception node further including a monitoring unit which monitors transmission qualities of the light signals according to the determination conducted by the rule determination unit or the disparity determination unit.

9. The system according to claim 6, wherein said rule determination unit determines whether the converted codes are codes which have been assigned by the preset encoding rule.

10. The system according to claim 6, wherein said rule determination unit determines the code errors per a certain bit string and outputs the result of the determination every predetermined period of time.

11. The system according to claim 7, wherein said disparity determination unit determines the running disparity errors per a certain bit string and outputs the result of the determination every predetermined period of time.
